(19) United States
(12) Patent Application Publication
(10) Pub. No.: US 2002/0103895 A1
(43) Pub. Date: Aug. 1, 2002

(54) Graphical user interface for dynamic viewing of packet exchanges over computer networks

(75) Inventor: Kevin Kang-Yue Chiang, Hayward, CA (US)

Correspondence Address: LAW OFFICES OF THOMAS E. SCHATZEL, A Professional Corporation, 16400 Lark Avenue, Suite 240, Los Gatos, CA, 95032-2547, US

(73) Assignee: Amplify.Net, Inc.

(21) Appl. No.: 09/729,733

(22) Filed: Dec. 4, 2000

(51) Int. Cl. G06F 15/173

(52) U.S. Cl. 709/224

(57) ABSTRACT

A network manager comprises a local group of network workstations and clients that periodically need access to a wide area network like the Internet. A class-based queue traffic shaper is placed in between and collects network-connection statistics. Such statistics are used in real-time to enforce multiple service-level agreement policies on individual connection sessions by limiting the maximum data throughput for each connection. The statistic data is stored in a large SQL-type database. A superview table is obtained and filtered for individual client views. Such superview table is loaded from a limited number of SQL CREATE VIEW statements. Client queries then pick and chose off-line from the superview table on their own.

### BACKGROUND OF THE INVENTION

1. Field of the Invention

The invention relates generally to computer network protocols and equipment, and more specifically to methods and systems for visual displays of computer network packet exchanges.

2. Description of the Prior Art

Access bandwidth is important to Internet users. New cable, digital subscriber line (DSL), and wireless “always-on” broadband-access together are expected to eclipse dial-up Internet access by 2001. So network equipment vendors are scrambling to bring a new generation of broadband access solutions to market for their service-provider customers. These new systems support multiple high speed data, voice and streaming video Internet-protocol (IP) services, and not just over one access media, but over any media.

Flat-rate access fees for broadband connections will shortly disappear, as more subscribers with better equipment are able to really use all that bandwidth and the systems' overall bandwidth limits are reached. One of the major attractions of broadband technologies is that they offer a large Internet access pipe that enables a huge amount of information to be transmitted. Cable and fixed point wireless technologies have two important characteristics in common. Both are “fat pipes” that are not readily expandable, and they are designed to be shared by many subscribers.

Although DSL allocates a dedicated line to each subscriber, the bandwidth becomes “shared” at a system aggregation point. In other words, while the bandwidth pipe for all three technologies is “broad”, it is always “shared” at some point and the total bandwidth is not unlimited. All broadband pipes must therefore be carefully and efficiently managed.

Internet protocol (IP) packets are conventionally treated as equals, and therein lies one of the major reasons for its “log jams”. When all IP-packets have equal right-of-way over the Internet, a “first come, first serve” service arrangement results. The overall response time and quality of delivery service is promised to be on a “best effort” basis only. Unfortunately all IP-packets are not equal, certain classes of IP-packets must be processed differently.

In the past, such traffic congestion has caused no fatal problems, only an increasing frustration from the unpredictable and sometimes gross delays. However, new applications use the Internet to send voice and streaming video IP-packets that mix-in with the data IP-packets. These new applications cannot tolerate a classless, best efforts delivery scheme, and include IP-telephony, pay-per-view movie delivery, radio broadcasts, cable modem (CM), and cable modem termination system (CMTS) over two-way transmission hybrid fiber/coax (HFC) cable.

Large database designs do not respond well or concern themselves with particular clients' needs. Structured query language (SQL) is typically used to formulate database queries. But getting the query right is difficult to do, and years of expertise are required. So a client that needs to send off an occasional query to an SQL database is unlikely to get it right, and such can impose severe performance penalties during run-time. Parameters peculiar to an individual client will not be accepted during run-time by SQL-View.

An SQL “CREATE VIEW” statement is used to specify a view. Such view is given a virtual table name, a list of attributes, and a query to specify the contents of the view. If none of the view attributes result from applying functions or arithmetic operations, then it is not necessary to specify attribute names for the view. They will be the same as the names of the attributes of the defining tables.

The latest Visual Basic language offers a tool to build an SQL query based on control properties or names of variables. The language tool can then form the SQL query and pass it to the SQL server. Such is still quite burdensome on the client application development, and imposes unnecessary performance penalties if client application developer has only limited database design experience.

What is needed is a way to pass parameters to Microsoft and Oracle database views during runtime that help reduce data clutter by filtering the responses to just that which was asked for.

### SUMMARY OF THE PRESENT INVENTION

It is therefore an object of the present invention to provide a database system and method for collecting and analyzing real-time information regarding user bandwidth demands in a network environment.

It is another object of the present invention to provide a simplified database query that reduces design and performance demands on both clients and databases.

Briefly, a network manager embodiment of the present invention comprises a local group of network workstations and clients that periodically need access to a wide area network like the Internet. A class-based queue traffic shaper is placed in between and collects network-connection statistics. Such statistics are used in real-time to enforce multiple service-level agreement policies on individual connection sessions by limiting the maximum data throughput for each connection. The statistic data is stored in a large SQL-type database. A superview is obtained and filtered for individual client views. Query context of such superview is loaded since it is first queried. Client queries can then pick and chose from the superview on their own much faster if the interested content is already in query context.

An advantage of the present invention is every database object can virtually have its own data without wasting computer resources.

A still further advantage of the present invention is database objects become easier to plan, design, implement, manage, and modify.

Another advantage of the present invention is database objects can more easily take advantage of query re-entrance.

These and many other objects and advantages of the present invention will no doubt become obvious to those of ordinary skill in the art after having read the following detailed description of the preferred embodiments which are illustrated in the drawing figures.

### IN THE DRAWINGS

FIG. 1 is a functional block diagram of bandwidth allocation system embodiment of the present invention with a gateway to the Internet;

FIG. 2 is a schematic diagram representing the data that flows over a computer network between a client and an Oracle-server that can be intercepted to gather session information like port assignments in an embodiment of the present invention similar to the one shown in FIG. 1;

FIG. 3 is a schematic diagram representing the data that flows over a computer network between a client and an HTTP-server that can be intercepted to gather session information like port assignments in an embodiment of the present invention similar to the one shown in FIG. 1;

FIG. 4 is a schematic diagram representing the data that flows over a computer network between a client and an H.323 server that can be intercepted to gather session information like port numbers in an embodiment of the present invention similar to the one shown in FIG. 1;

FIGS. 5A and 5B are a flowchart and a schematic diagram that represent how data is intercepted from H.323 type datapacket exchanges in an embodiment of the present invention similar to the one shown in FIG. 1;

FIGS. 6A and 6B are a flowchart and a schematic diagram that represent how data is intercepted from TCP/IP type HTTP datapacket exchanges in an embodiment of the present invention similar to the one shown in FIG. 1;

FIGS. 7A and 7B are a flowchart and a schematic diagram that represent how data is intercepted from Oracle-type datapacket exchanges in an embodiment of the present invention similar to the one shown in FIG. 1;

FIG. 8 is a flowchart of a class-based queue method embodiment of the present invention that checks to see if particular datapackets can be sent through immediately or must be buffered to stay within allowed bandwidth parameters;

FIG. 9 is a flowchart of a class-based queue method embodiment of the present invention that checks to see if additional bandwidth is available;

FIG. 10 is a flowchart of a class-based queue processing method embodiment of the present invention that checks to see if particular datapackets can be sent through immediately or must be buffered to stay within allowed bandwidth parameters;

FIG. 11 is a flowchart of a method embodiment of the present invention for defining user bandwidth parameters;

FIG. 12 is a drawing that represents the plurality of user virtual pipes that can co-exist within a single physical fiber-optic cable in an embodiment of the present invention;

FIG. 13 is a functional block diagram of a class-based queue traffic shaper embodiment of the present invention similar to the one shown in FIG. 1; and

FIG. 14 is a functional block diagram of a network service management system embodiment of the present invention.

### DETAILED DESCRIPTION OF THE PREFERRED EMBODIMENTS

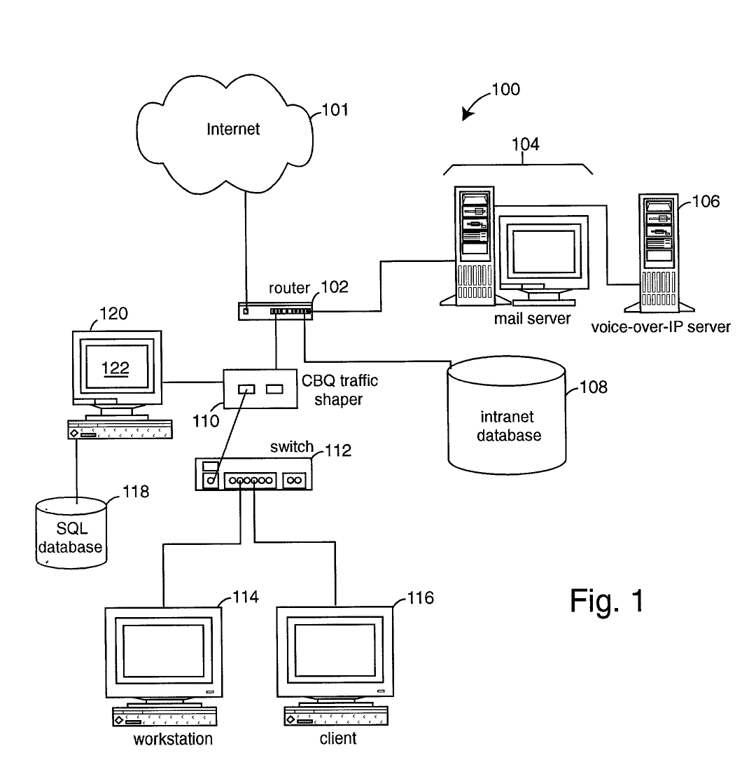

FIG. 1 illustrates a network embodiment of the present invention, and is referred to herein by the general reference numeral 100. The Internet 101 or other wide area network (WAN) is accessed through a network router 102. An e-mail server 104 and voice-over-IP server 106 have direct, unrestricted access to the Internet 101 through the router 102. A local database 108 is used, e.g., to store e-mail and voice messages.

A class-based queue (CBQ) traffic shaper 110 dynamically controls the maximum bandwidth for each connection through a switch 112 to any workstation 114 or any client 116. Policies are used inside the CBQ traffic shaper to monitor and limit every connection involving an IP-address behind the switch 112. A preferable exception is to allow any workstation 114 or any client 116 practically unlimited access bandwidth to their own local e-mail server 104 and voice-over-IP server 106. Such exception is handled as a policy override.

The policies are defined and input by a system administrator. Internal hardware and software are used to spool and despool packet streams through at the appropriate bandwidths. In business model implementations of the present invention, subscribers are charged various fees for different levels of service, e.g., better bandwidth and delivery time-slots. For example, the workstations 114 and clients 116 could be paying customers who have bought particular levels of Internet-access service and who have on-demand service needs. One such on-demand service could be the peculiar higher bandwidth and class priority needed to support an IP-telephone call. A use-fee or monthly subscription fee could be assessed to be able to make such a call.

If the connection between the WAN 101 and the router 102 is a digital subscriber line (DSL) or other asymmetric link, the CBQ traffic shaper 110 is preferred to have a means for enforcing different policies for the same local IP-addresses transmit and receive ports.

A network embodiment of the present invention comprises a local group of network workstations and clients with a set of corresponding local IP-addresses. Those local devices periodically need access to a wide area network (WAN). A class-based queue (CBQ) traffic shaper is disposed between the local group and the WAN, and provides for an enforcement of a plurality of service-level agreement (SLA) policies on individual connection sessions by limiting a maximum data throughput for each such connection. The class-based queue traffic shaper preferably distinguishes amongst voice-over-IP (voIP), streaming video, and datapackets. Any sessions involving a first type of packet can be limited to a different connection-bandwidth than another session-connection involving a second type of packet. The SLA policies are attached to each and every local IP-address, and any connection-combinations with outside IP-addresses can be ignored.

In alternative embodiments, the CBQ traffic shaper 110 is configured so that its SLA policies are such that any policy-conflicts between local IP-address transfers are resolved with a lower-speed one of the conflicting policies taking precedence. The CBQ traffic shaper is configured so its SLA policies are dynamically attached and readjusted to allow any particular on-demand content delivery to the local IP-addresses.

The data passed back and forth between connection partners during a session must be tracked by the CBQ traffic shaper 110 if it is to have all the information needed to classify packets by application. Various identifiable patterns will appear that will signal new information. These patterns are looked for by a dynamic application classifier (DAC) that monitors the datapacket exchanges. Such DAC is preferably included within the CBQ traffic shaper 110. An automatic bandwidth manager (ABM) is also included that controls the throughput bandwidth of each user by class assignment.

A database 118 is used to store policy information configured to manage bandwidth utilization for computers connected to switch 112 and to collect network-traffic statistics from the CBQ traffic. A workstation 120 is connected to the CBQ traffic shaper 110 such that a user can observe and control network traffic. A graphic user interface (GUI) 122 enables a variety of database queries to be input and the results “viewed”. A superview is created from the CREATE VIEW function and comprises a set of policy and statistical data about the network clients. A number of filtered views can be dynamically executed by parameters received from the network clients, and are filled with selected components copied from the superview.

The superview is loaded with all the data that can be anticipated during the design to be queried by a client via a filtered view. Every client query will be satisfied by a custom-created filtered view loaded from combinations of data from the superview. Complicated SQL-query is actually generated or required by any particular client application. Instead, a single or a single group of SQL-views that build with sophisticated queries are built-in to the database design for routine execution during run-time. It provides a way to hide the complexity of data relationship to SQL statements at the client.

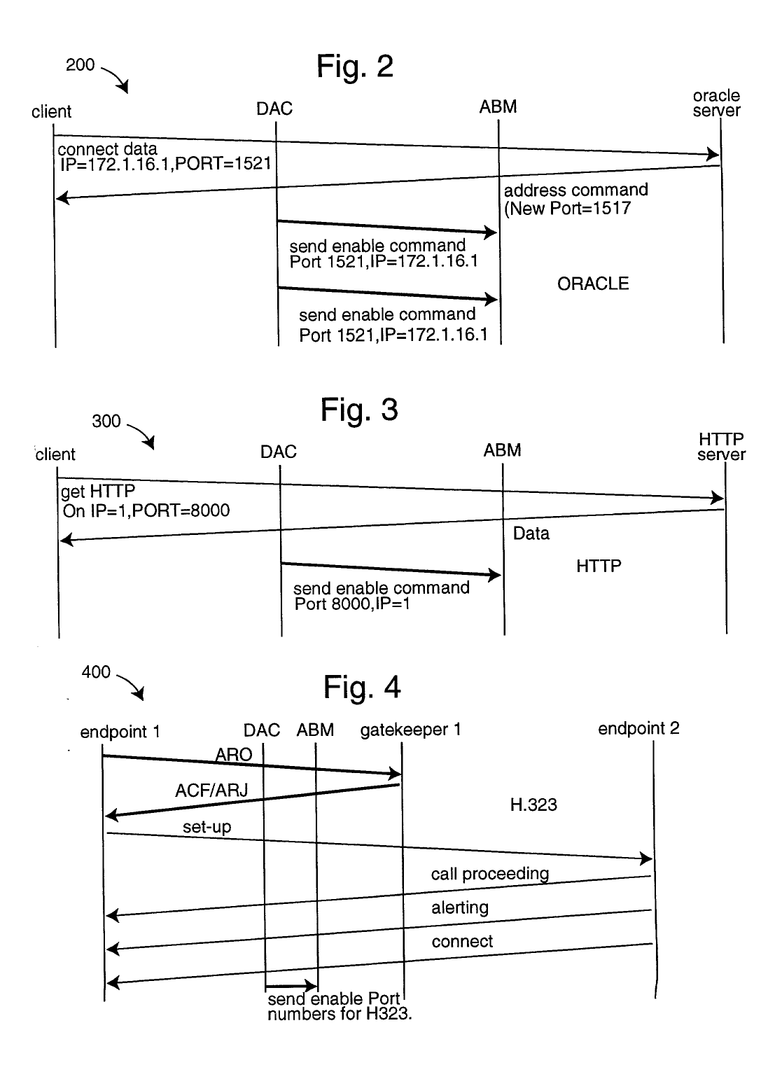

FIG. 2 represents a process 200 by which the DAC and ABM capture port information in an Oracle-type session. For example, if the bandwidth manager and DAC are implemented within the CBQ traffic shaper 110 (FIG. 1), a client 116 can begin by sending connect data, e.g., IP=172.1.16.1, port=1521. This information is noted and passed through the CBQ traffic shaper 110 to the Oracle server. The response is an address command, new port=1517, and thus an Oracle server is identified to both the DAC and the client who initiated the exchange. The new ports identified in the address command are added to a list of Oracle application port numbers of the ABM.

FIG. 3 represents a process 300 by which the DAC and ABM capture port information in an HTTP-type session. If any client 116 sends a “GET_msg”, e.g., on IP=1, port=8000, the port number information is added to a list of HTTP application port numbers of the ABM.

So-called “H.323” is an industry standard that specifies the components, protocols, and procedures that provide multimedia communications services over packet networks like the Internet. The H.323 is used to carry real-time audio, video, and data communications. Voice-over-IP (VoIP) and IP-telephony require a guaranteed quality of service (QoS) that is included in Version-2 of the H.323. A client request to access the WAN 101 is made via an H.323 RAS-message admissionRequest (ARQ) command to the gatekeeper (e.g., router 102). The ARQ is either answered by being confirmed (ACF) or rejected (ARJ). Bandwidth allocation requests can be changed with BRQ command. Q.931 messaging then commences with alerting, call proceeding, connect, setup, release complete, and status messages.

Gateway embodiments of the present invention preferably have special policies that attach to the IP-addresses used for the gateways. For example, mail servers, video servers, and VoIP servers can have dedicated gateways with policies simply managed by IP-address.

Each SLA has a committed information rate (CIR) which is the minimum bandwidth guaranteed to a subscriber. If such subscriber exceeds the CIR, and there is excess bandwidth in the channel, then a maximum burst rate (MBR) can be applied. If many subscribers are in a MBR state, then a bursting priority is needed. Each subscriber's SLA policy can be set to a schedule, seven days a week, twenty-four hours a day.

Each subscriber is allocated a virtual-pipe within a real broadband access channel, pipe, or backbone. Such virtual-pipe is defined by IP/MAC addresses, and/or TCP/UDP port numbers. For example, Table I shows some common TCP-port numbers used by popular applications, and Table II shows common UDP-port numbers. Seeing traffic on these port numbers is a strong indication that the clients and servers are running the corresponding applications.

TABLE I
(TCP)

| | |
|---|---|
| FTP | 20, 21 |
| Telnet | 23 |
| SMTP | 25 |
| DNS | 53 |
| Gopher | 70 |
| WWW http | 80-84 |
| DLSW read | 2065 |
| DLSW write | 2067 |

TABLE II
(UDP)

| | |
|---|---|
| DNS | 53 |
| TFTP | 69 |
| SNMP | 161 |
| SNMPTRAP | 162 |

FIG. 4 represents a process 400 by which the DAC and ABM classify traffic as being H.323 type and control it thereafter. The DAC constantly looks for an H225 message access request ARQ, e.g., while it also asynchronously looks for many other classes of datapackets too. The gateway (e.g., router 102) responds with the ACF command which includes a Port-A address. The bandwidth requested is saved in the application state machine. The DAC can then provide H.323 port numbers for the ABM.

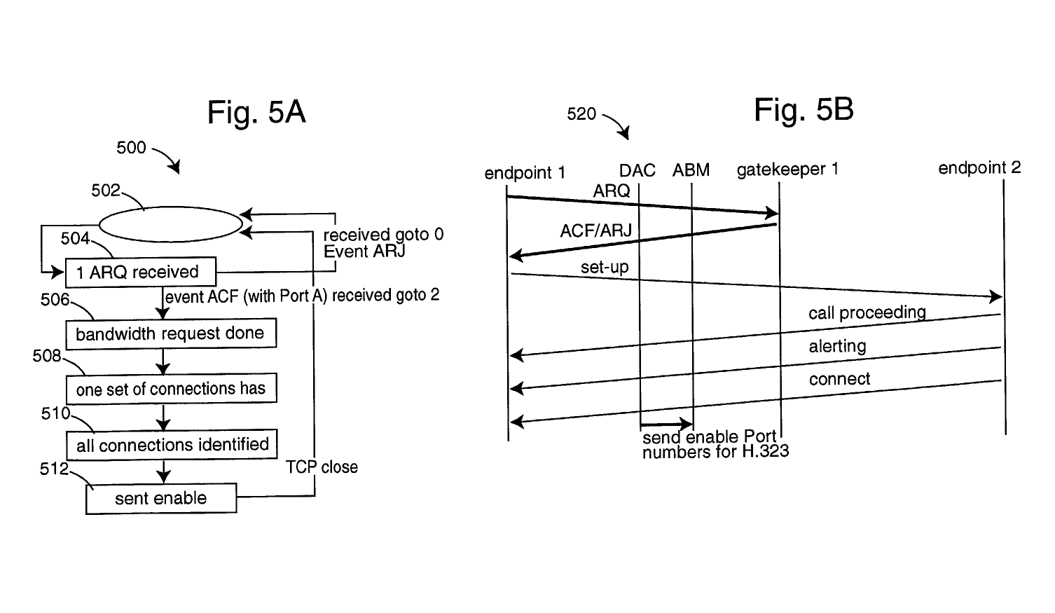

FIG. 5A represents a state machine 500 that monitors H.323 datapacket exchanges, e.g., within a DAC. An idle state 502 waits for an access-request “ARJ” event. A state 504 has recognized an ARJ and looks for an access-confirmed “ACF” event. A state 506 collects bandwidth information. A state 508 gathers connection information. A step 510 confirms all connections have been identified. A step 512 looks for connection complete.

FIG. 5B represents the H.323 connection progress 520. A call endpoint-1 sends an ARQ through the DAC and ABM to a gatekeeper-1. An ACF (confirmed) or ARJ (rejected) is returned. If ACF, a setup information is sent through the DAC, ABM, and gatekeeper-1 to an endpoint-2. It returns call proceeding, alerting, and connect information. These are all intercepted by the DAC so the ABM can be properly instructed for this class of user connection. For example, the H.323 enable port numbers are passed by the DAC to the ABM.

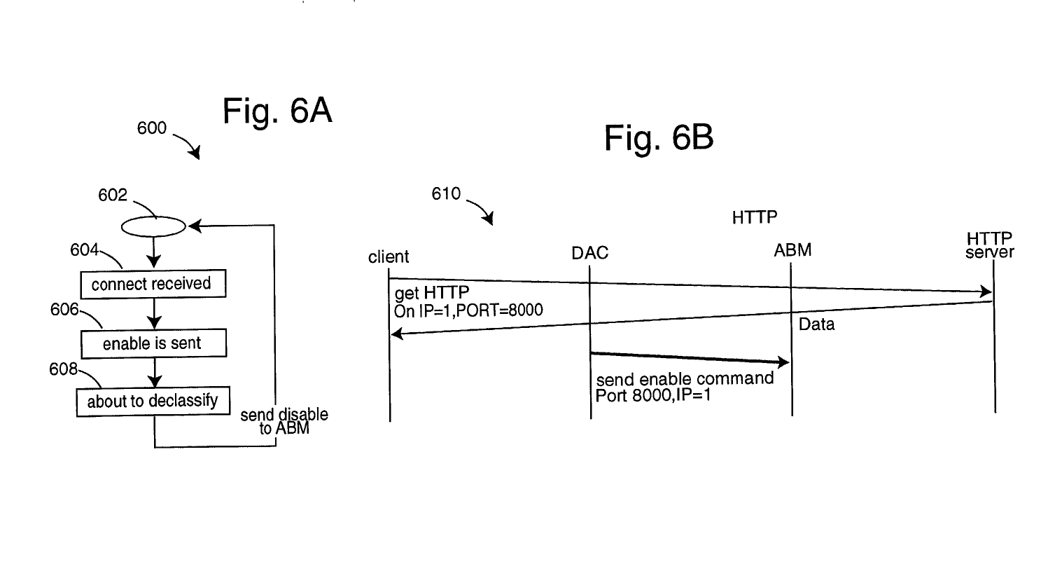

FIG. 6A represents a state machine 600 that monitors hypertext markup language protocol (HTTP) datapacket exchanges, e.g., within a DAC. An idle state 602 waits for a connection to be received on an expected port. A step 604 recognizes the connection and logs the port number for the ABM. A step 606 sees that an enable is sent. A step 608 recognizes the end of a client-server connection session, and sends a disable for the temporary class to the ABM.

FIG. 6B represents an HTTP connection progress 610. A client sends a request through the DAC and ABM to a HTTP server. It returns a connect information, e.g., a port selection. These are intercepted by the DAC so the ABM can be properly instructed for this class of user connection. For example, the port numbers are passed by the DAC to the ABM.

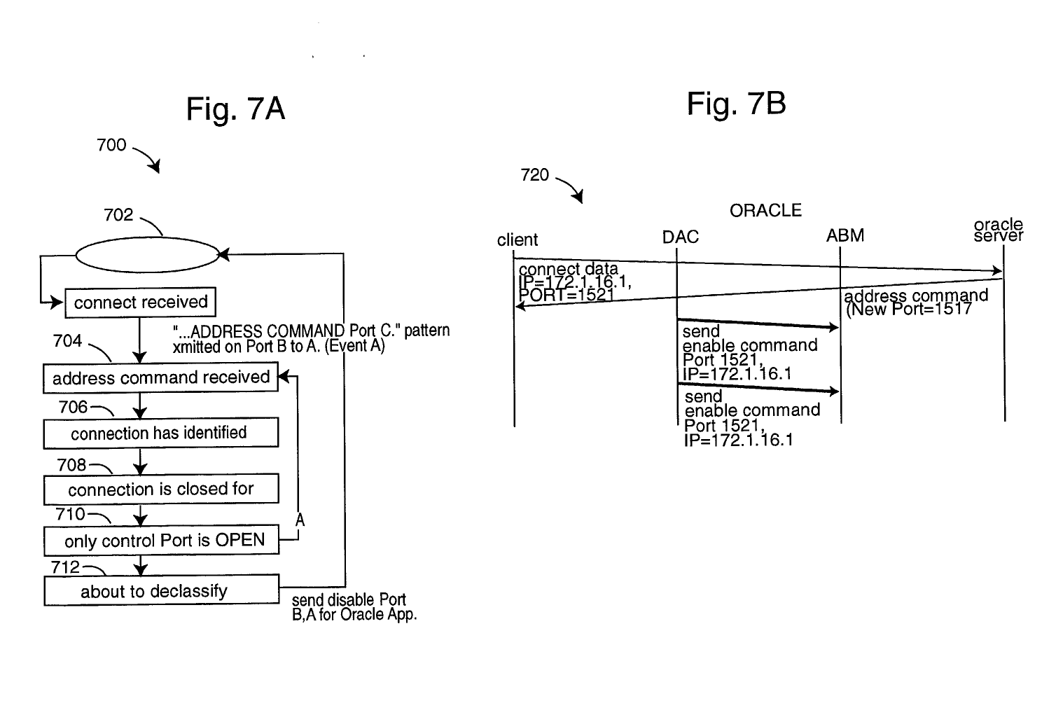

FIG. 7A represents a state machine 700 that monitors Oracle-type datapacket exchanges within a DAC, for example. An idle state 702 waits for a connection to be received on an expected port. A step 704 recognizes that an address command has been received. A step 706 sees that a connection is identified. A step 708 recognizes the end of the Oracle connection session. A step 710 looks to see if only the control port is open. A step declassifies the temporary Oracle-application class and sends a corresponding disable to the ABM.

FIG. 7B represents an Oracle connection progress 720. A client sends a session-connection request through the DAC and ABM to an Oracle server. Such server returns connection information, e.g., an address command. These are intercepted by the DAC so the ABM can be properly instructed for this class of user connection. For example, the port and IP-numbers are passed by the DAC to the ABM.

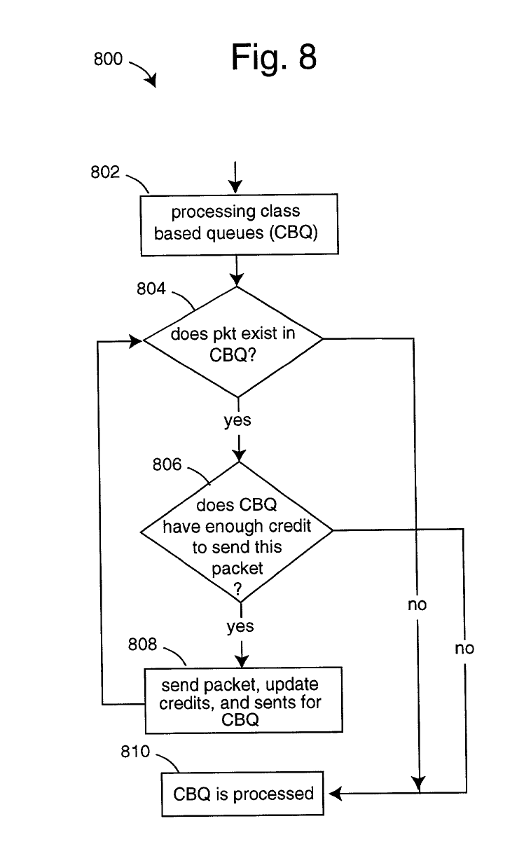

FIG. 8 illustrates a class-based queue processing method 800 that starts with a step 802. Such executes, typically, as a subroutine in the CBQ traffic shaper 110 of FIG. 1. A step 804 decides whether an incoming packet has a recognized class. If so, a step 806 checks that class currently has available bandwidth. If yes, a step 808 sends that datapacket on to its destination without detaining it in a buffer. Step 808 also deducts the bandwidth used from the class' account, and updates other statistics. Step 808 returns to step 804 to process the next datapacket. Otherwise, a step 810 simply returns program control.

In general, recognized classes of datapackets will be accelerated through the system by virtue of increased bandwidth allocation. Datapackets with unrecognized classes are given lowest priority, and are stalled in buffers whenever guaranteed bandwidths are being disbursed under contracted-for user classes.

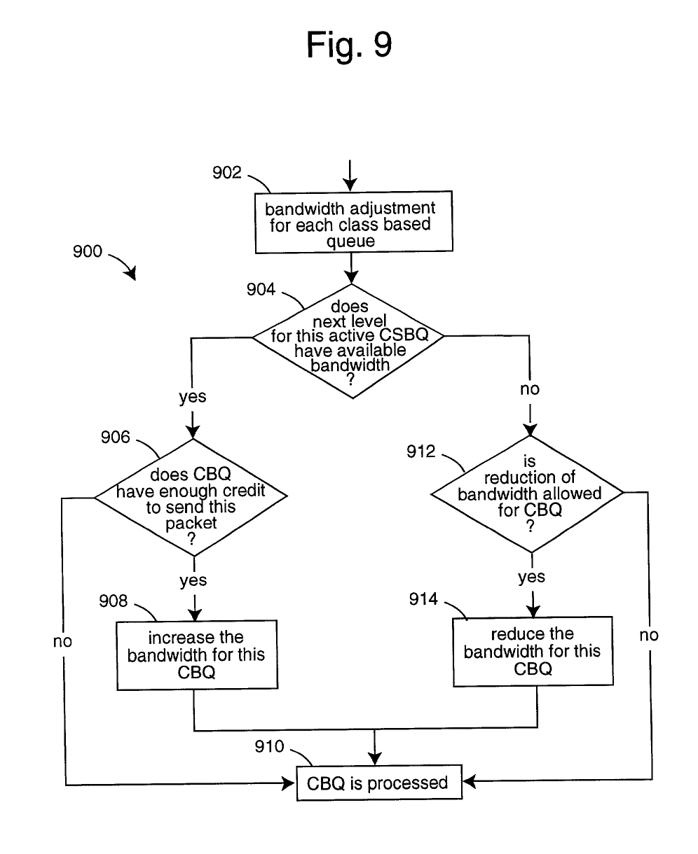

A bandwidth adjustment method 900 is represented by FIG. 9. It starts with a step 902. A step 904 decides if the next level for a current class-based queue (CBQ) has any available bandwidth that could be “borrowed”. If yes, a step 906 checks to see if the CBQ has enough “credit” to send the current datapacket. If yes, a step 908 temporarily increases the bandwidth ceiling for the CBQ and the current datapacket. A step 910 returns program control to the calling routine after the CBQ is processed. A step 912 is executed if there is no available bandwidth in the active CBQ. It checks to see if a reduction of bandwidth is allowed. If yes, a step 914 reduces the bandwidth.

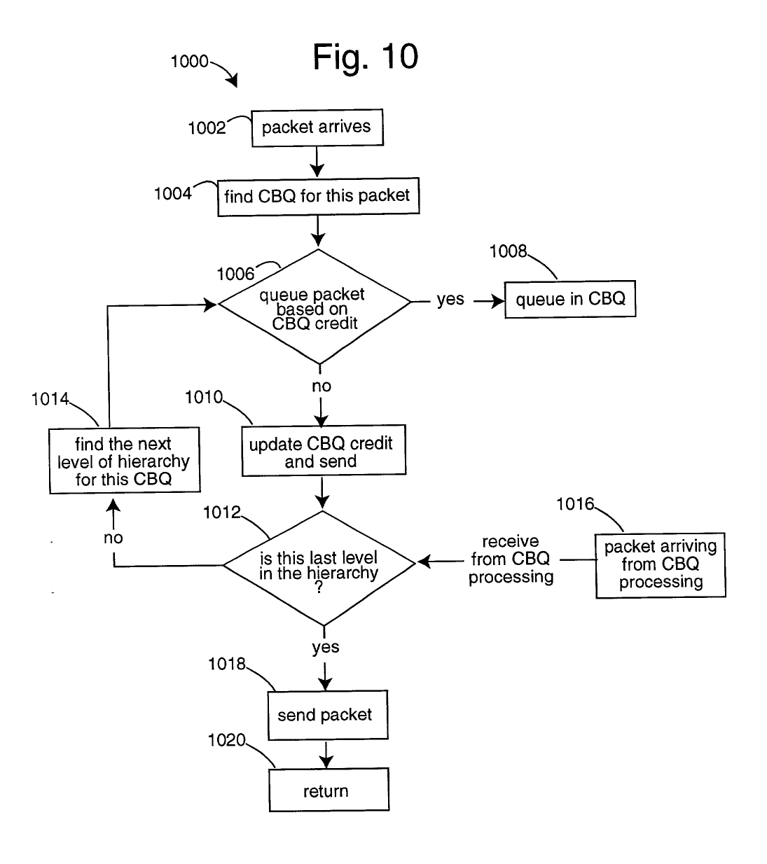

A packet process 1000 is illustrated in FIG. 10 and is a method embodiment of the present invention. It begins with a step 1002 when a datapacket arrives. A step 1004 attempts to find a CBQ that is assigned to handle this particular class of datapacket. A step 1006 checks to see if the datapacket should be queued based on CBQ credit. If yes, a step 1008 queues the datapacket in an appropriate CBQ. Otherwise, a step 1010 updates the CBQ credit and sends the datapacket. A step 1012 checks to see if the last level in a hierarchy. If not, program control loops back through a step 1014 that finds the next hierarchy level. A step 1016 represents a return from a CBQ processing subroutine like that illustrated in FIG. 9. If the last level of the hierarchy is detected in step 1012, then a step 1018 sends the datapacket. A step 1020 returns program control to the calling program.

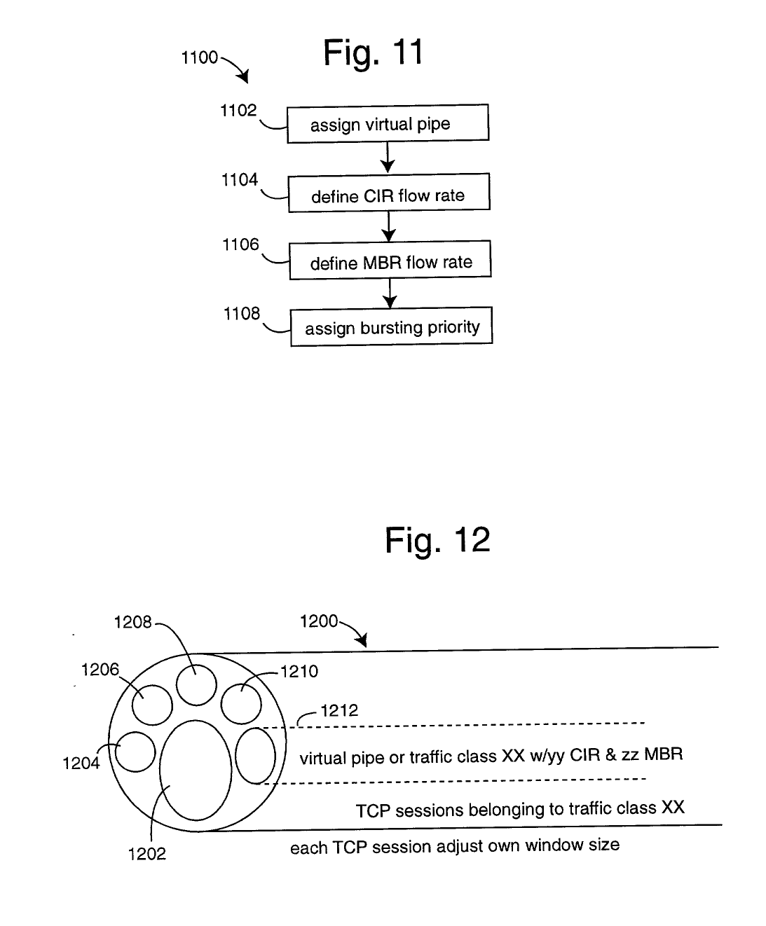

FIG. 11 represents a user setup program embodiment of the present invention, and is referred to herein by the general reference numeral 1100. The program 1100 includes a step 1102 for assigning a virtual pipe. A step 1104 defines the CIR flow rate. A step 1106 defines the MBR flow rate. And, a step 1108 assigns the bursting priority.

FIG. 12 represents how a physical fiberoptic cable 1200 can be thought to consist of many constituent virtual pipes 1202, 1204, 1206, 1208, 1210, and 1212. These virtual pipes are, of course, not physically manifested as shown in the Fig. Each virtual pipe can be of different size, and each can freely vary in size dynamically over time according to user parameters, fees paid, classes of datapackets, bursts, available bandwidth, etc.

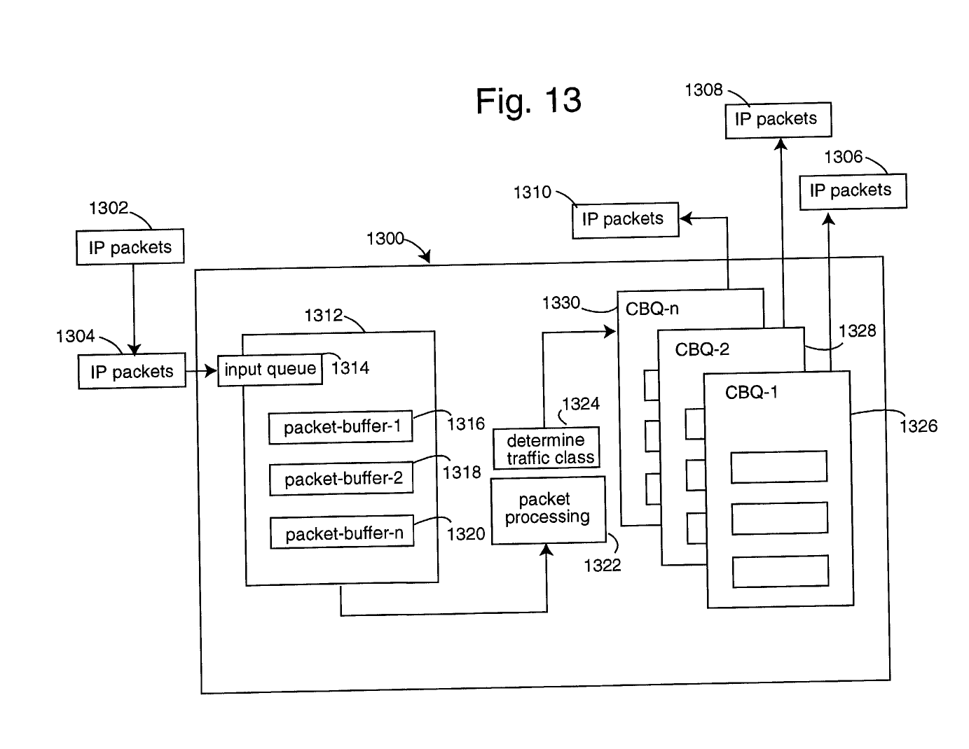

FIG. 13 illustrates a CBQ traffic shaper 1300 in an embodiment of the present invention. The CBQ traffic shaper 1300 receives an incoming stream of datapackets, e.g., 1302 and 1304. Such are typically transported with TCP/IP on a computer network like the Internet. Datapackets are output at controlled rates, e.g., as datapackets 1306, 1308, and 1310. A typical CBQ traffic shaper 1300 would have two mirror sides, one for incoming and one for outgoing for a full-duplex connection. Here in FIG. 13, only one side is shown and described to keep this disclosure simple and clear.

A dynamic application classifier (DAC) 1312 has an input queue 1314. It has several packet buffers, e.g., as represented by packet-buffers 1316, 1318, and 1320. Each incoming datapacket is put a buffer to wait for classification processing, e.g., as outlined in the processes of FIGS. 2-10. A packet processor 1322 and a traffic-class determining processor 1324 distribute datapackets that have been classified and those that could not be classified into appropriate class-based queues (CBQ).

A collection of CBQ's constitutes an automatic bandwidth manager (ABM). Such enforces the user service level agreement policies that attach to each class. Individual CBQ's are represented in FIG. 13 by CBQ 1326, 1328, and 1330. Each CBQ can be implemented with a first-in, first-out (FIFO) register that is clocked at the maximum allowable rate (bandwidth) for the corresponding class.

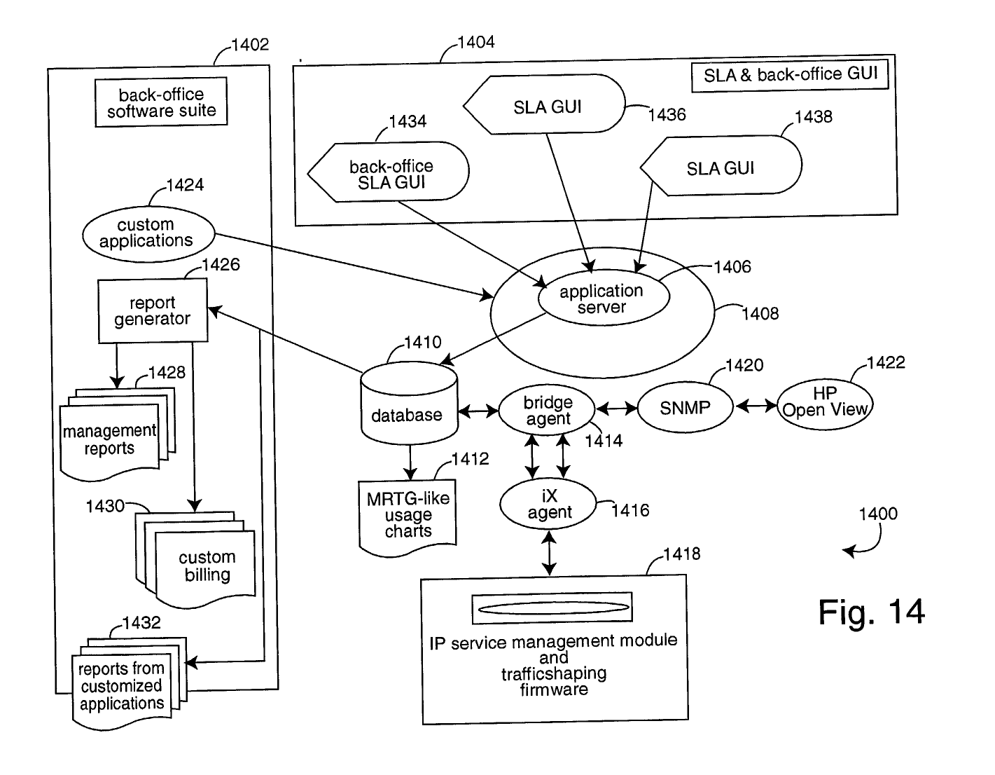

FIG. 14 represents a network service management system 1400 that allows users to define, manage, and automate bandwidth service flows for provisioning and controlling network operations. Such can also capture accounting, customer billing, network planning, capacity analysis, and other critical usage information. The system 1400 is typically implemented with a back-office software suite 1402 and graphical user interface (GUI) 1404 coupled to an application server 1406 and host platform 1408. A relational database 1410 is used to store user service level agreement policies, usage data collection, usage-based accounting, trend analysis, capacity scheduling/forecasting, and a bandwidth provisioning valve, monitor, and meter. The database 1410 resides on a host server, e.g., Windows-NT, Sun-Solaris, etc.

The database 1410 issues multi-router traffic grapher (MRTG) type usage charts 1412. It further communicates through a bridge agent 1414 and X-Windows agent 1416 with an IP-service management module 1418. Such includes a traffic shaping firmware and operates similarly to the CBQ traffic shaper 110 (FIG. 1). A simple network management protocol (SNMP) message 1420 interfaces to a Hewlett-Packard OpenView type network management platform 1422. A manager node solicits and interprets data about the network devices and network traffic.

The back-office software suite 1402 includes a set of custom applications 1424 that execute on the host platform 1408, and a report generator 1426. The latter generates management reports 1428, custom billing 1430, etc. Customized application reports 1432 are sourced from the database 1410.

The GUI 1404 comprises a back-office SLA GUI 1434 and at least one front-end SLA GUI 1436 and 1438. These GUI's dynamically allow a variety of users and inquiries to be accommodated. The front-end GUI's are based on JAVA and enable the network manager 1422 to classify, configure, and store customer IP service levels in the database 1410. The back-office GUI is used to retrieve usage information and generate various management reports.

The network manager 1422 can be used to invoke dynamic views of a customer's actual IP consumption by invoking MRTG-like real-time usage charts using a back-office GUI 1434. Customer billing and other usage-based management reports may also be requested via the back-office GUI 1434.

The IP service module 1418 shapes and smoothes network traffic flow and enforces the policies set by the service level agreements. It uses virtualpipes, traffic class, usage service level agreement policy, class-based queuing, and a trafficshaping algorithm implemented in the firmware.

Virtualpipes treat a wide area network (WAN) pipe as many small, “adaptive” pipes, each assigned to a traffic class. A traffic class is defined in terms of P/MAC addresses and/or TCP/LJDP ports as specified by an SLA policy. Each SLA policy is expressed as a committed information rate (CIR), maximum burst rate (MBR), priority bursting rate, etc.

Usage is measured in real-time and managed dynamically on a virtualpipe basis. At any one time, many thousands of IP sessions may be flowing through a virtualpipe. As long as the usage falls within its CIR, traffic flows through uninterrupted. If, however, the data rate temporarily exceeds its assigned SLA, it is queued and later forwarded. Each virtualpipe is assigned two queues, one each for inbound and outbound traffic. Class-based queuing prevents bursty IP traffic from being dropped, and at the same time, invokes TCP/IP's inherent flow control mechanism to reduce the transmission rate. Each TCP/IP session is, in effect, allowed to control its own transmission rate based on SLA policies.

The back-office software suite 1402 resides on a host server and interacts with the network manager 1422 via the GUI 1404. The report generator 1426 is a “turnkey” application that responds to commands from the GUI 1404. It retrieves and formulates requested usage information from the database 1410, then generates customer billing information and other usage-based management reports in graphical screen displays or in printed form. The back-office software suite 1402 preferably includes a bundled usage accounting package that enables a service provider to generate customer invoices from actual usage data captured in the database 1410.

The network manager 1422 can request other usage-based information via the back-office GUI 1434, e.g., accounts, P/MAC addresses, user groups, user groups within accounts, P/MAC addresses within user groups. These can be further qualified by specific time period, peak usage, and usage consumption volume.

A virtual table is created from the database 1410 by creating a “view”. The SQL-statement CREATE VIEW is used, e.g., as in Table I. A “WHERE” clause is not used because all elements are requested in a “superview”.

TABLE I
CREATE VIEW dbo.amp_v_coge_ent_policy_4
AS

| | |
|---|---|
| SELECT | amp_v_coge_ent_policy_3.policy_id, |
| | amp_v_coge_ent_policy_3.device_ID, |
| | amp_v_coge_ent_policy_3.account_ID, |
| | amp_v_coge_ent_policy_3.user_group_name, |
| | amp_v_coge_ent_policy_3.start_IP, |
| | amp_v_coge_ent_policy_3.end_IP, |
| | amp_v_coge_ent_policy_3.tcp_group, |
| | amp_service_udp.udp_group, |
| | amp_v_coge_ent_policy_3.service_set_name, |
| | amp_v_coge_ent_policy_3.service_name, |
| | amp_v_coge_ent_policy_3.bandwidth_set_name, |
| | amp_v_coge_ent_policy_3.CIR_in, |
| | amp_v_coge_ent_policy_3.CIR_out, |
| | amp_v_coge_ent_policy_3.MBR_in, |
| | amp_v_coge_ent_policy_3.MBR_out, |
| | amp_v_coge_ent_policy_3.priority_ID, |
| | amp_v_coge_ent_policy_3.attack, |
| | amp_v_coge_ent_policy_3.retreat, |
| | amp_v_coge_ent_policy_3.direction_mask, |
| | amp_v_coge_ent_policy_3.alert_ID, |
| | amp_v_coge_ent_policy_3.override, |
| | amp_v_coge_ent_policy_3.schedule, |
| | amp_v_coge_ent_policy_3.day_of_the_week, |
| | amp_v_coge_ent_policy_3.start_time, |
| | amp_v_coge_ent_policy_3.end_time, |
| | amp_v_coge_ent_policy_3.device_vlan_id, |
| | amp_v_coge_ent_policy_3.user_group_vlan_id, |
| | amp_v_coge_ent_policy_3.user_group_type |
| FROM | amp_v_coge_ent_policy_3 LEFT OUTER JOIN |
| | amp_service_udp ON |
| | amp_v_coge_ent_policy_3.service_name= |
| | amp_service_udp.service_name |

A “dynamic view” is constructed from data filtered from the superview table. Each new dynamic view does not require that a complex SQL-query be generated for the client.

Instead, the new dynamic view is filtered from possibly already available data in the superview. When a filter table is updated at run-time, the dynamic views each only receive the result set of interest. This simplifies the information request and delivery. Table II illustrates the creation of a dynamic view.

TABLE II
CREATE VIEW dbo.amp_v_coge_ent_policy_4_this_hour
AS

| | |
|---|---|
| SELECT | amp_v_coge_ent_policy_4.policy_id |
| | amp_v_coge_ent_policy_4.device_ID |
| | amp_v_coge_ent_policy_4.account_ID |
| | amp_v_coge_ent_policy_4.user_group_name |
| | amp_v_coge_ent_policy_4.start IP |
| | amp_v_coge_ent_policy_4.end_IP |
| | amp_v_coge_ent_policy_4.tcp_group |
| | amp_v_coge_ent_policy_4.udp_group, |
| | amp_v_coge_ent_policy_4.service_set_name, |
| | amp_v_coge_ent_policy_4.service_name, |
| | amp_v_coge_ent_policy_4.bandwidth_set_name, |
| | amp_v_coge_ent_policy_4.CIR_in, |
| | amp_v_coge_ent_policy_4.CIR_out, |
| | amp_v_coge_ent_policy_4.MBR_in, |
| | amp_v_coge_ent_policy_4.MBR_out, |
| | amp_v_coge_ent_policy_4.attack, |
| | amp_v_coge_ent_policy_4.retreat, |
| | amp_v_coge_ent_policy_4.schedule, |
| | amp_u_coge_this_hour.today, |
| | amp_u_coge_this_hour.start_hour, |
| | amp_u_coge_this_hour.end_hour, |
| | amp_v_coge_ent_policy_4.direction_mask, |
| | amp_v_coge_ent_policy_4.alert_ID, |
| | amp_v_coge_ent_policy_4.override, |
| | amp_v_coge_ent_policy_4.day_of_the_week, |
| | amp_v_coge_ent_policy_4.start_time, |
| | amp_v_coge_ent_policy_4.end_time, |
| | amp_v_coge_ent_policy_4.device_vlan_id, |
| | amp_v_coge_ent_policy_4.user_group_vlan_id, |
| | amp_v_coge_ent_policy_4.user_group_type |
| FROM | amp_v_coge_ent_policy_4INNER JOIN |
| | amp_u_coge_this_hour ON |
| | amp_v_coge_ent_policy_4.day_of_the_week= |
| | amp_u_coge_this_hour.today |
| | AND |
| | amp_v_coge_ent_policy_4.start_time<= |
| | amp_u_coge_this_hour.start_hour |
| | AND |
| | amp_v_coge_ent_policy_4.end_time>= |
| | amp_u_coge_this_hour.end_hour |
| | AND |
| | amp_v_coge_ent_policy_4.device_ID= |
| | amp_u_coge_this_hour.device_id |

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

What is claimed is:

1. A network, comprising:
a local group of network workstations and clients with a set of corresponding local IP-addresses, and that periodically need access to a wide area network (WAN);
a class-based queue (CBQ) traffic shaper is disposed between the local group and the WAN, and provides for an enforcement of a plurality of service-level agreement (SLA) policies on individual connection sessions by limiting a maximum data throughput for each such connection;
a database providing for policy-information collection of network-traffic statistics from the CBQ traffic shaper and including a structured query language (SQL) with a CREATE VIEW function;
a superview table created from said CREATE VIEW function and containing a set of policy and statistical data about a plurality of network clients;
a plurality of dynamic views created from said CREATE VIEW function that join the superview with a filter table; and
a plurality of filter tables dynamically populated by parameters received from said plurality of network clients, and fill the dynamic views with selected components copied from the superview table.

2. The network of claim 1, wherein:
the CBQ traffic shaper is configured such that said SLA policies are attached to each and every local IP-address, and any connection combinations with outside IP-addresses are ignored.

3. The network of claim 1, wherein:
the CBQ traffic shaper is configured such that said SLA policies are such that any policy-conflicts between local IP-address transfers are resolved with a lower-speed one of said conflicting policies taking precedence.

4. The network of claim 1, wherein:
the CBQ traffic shaper is configured such that said SLA policies are dynamically attached and readjusted to allow any particular on-demand content delivery to said local IP-addresses.

5. A network, comprising:
a local group of network workstations and clients with a set of corresponding local IP-addresses, and that periodically need access to a wide area network (WAN);
a class-based queue (CBQ) traffic shaper is disposed between the local group and the WAN, and provides for an enforcement of a plurality of service-level agreement (SLA) policies on individual connection sessions by limiting a maximum data throughput for each such connection;
a database providing for collection of network-traffic statistics from the CBQ traffic shaper and including a structured query language (SQL) with a CREATE VIEW function;
a superview table created from said CREATE VIEW function and containing a set of statistical data about a plurality of network clients;
a plurality of dynamic views created from said CREATE VIEW function that join the superview with a filter table; and
a plurality of filter tables dynamically populated by parameters received from said plurality of network clients, and fill the dynamic views with selected components copied from the superview table;
wherein, the class-based queue traffic shaper distinguishes streaming video datapackets from other types and affords said streaming video datapackets a throughput priority.

6. The network of claim 5, wherein:
the CBQ traffic shaper is configured such that said SLA policies are attached to each and every local IP-address, and any connection combinations with outside IP-addresses are ignored.

7. The network of claim 5, wherein:
the CBQ traffic shaper is configured such that said SLA policies are such that any policy-conflicts between local IP-address transfers are resolved with a lower-speed one of said conflicting policies taking precedence.

8. The network of claim 5, wherein:
the CBQ traffic shaper is configured such that said SLA policies are dynamically attached and readjusted to allow an on-demand streaming video delivery to said local IP-addresses.
